(19) United States
(12) Patent Application Publication
(10) Pub. No.: US 2011/0106320 A1
(43) Pub. Date: May 5, 2011

(54) METHOD AND APPARATUS FOR GENERATING AN IRRIGATION SCHEDULE

(75) Inventor: Randall B. Hall, La Habra Heights, CA (US)

(73) Assignee: Rain Bird Corporation, Azusa, CA (US)

(21) Appl. No.: 12/610,178

(22) Filed: Oct. 30, 2009

(51) Int. Cl. G05D 7/06; G06F 3/048

(52) U.S. Cl. 700/284; 715/771

(57) ABSTRACT

Methods and devices are provided for creating an irrigation schedule for an area to be irrigated. In one implementation, an apparatus for creating an irrigation schedule for an area, the area having a plurality of characteristics, comprises a computer readable medium storing a set of instructions. The apparatus also includes a processor coupled to the computer readable medium and adapted to execute the set of instructions to cause the display of a graphical user interface comprising a plurality of sets of user selectable graphic images, each set of user selectable graphic images corresponding to a characteristic of the area, and each set having user selectable graphic images corresponding to different properties of the characteristic. The processor is further adapted to execute the set of instructions to generate the irrigation schedule in response to user selection of at least one user selectable graphic image from each of the plurality of sets.

### BACKGROUND OF THE INVENTION

1. Field of the Invention

The present invention relates generally to irrigation schedules for use by an irrigation controller, and more specifically to generating an irrigation schedule for use by the irrigation controller.

2. Discussion of the Related Art

Efficient and optimal irrigation is becoming more common as irrigation water becomes an increasingly valuable commodity. Many municipalities have taken and continue to take drastic steps in order to conserve water. For example, regulations to conserve water have been enacted to affect residential users in such regions. Various irrigation techniques exist to optimize the use of irrigation water.

When programming a watering schedule for a typical irrigation controller, a user must have sophisticated knowledge in various aspects of the landscape in which they wish to irrigate in order to create a watering schedule that will provide enough irrigation without overwatering. Additionally, the user must understand and enter proper watering days, start times and durations to meet the needs of the landscape. This is a complicated task for an unsophisticated user. Users without the requisite knowledge often times arbitrarily enter schedules into the irrigation controller and consequently fail to efficiently irrigate.

### SUMMARY OF THE INVENTION

Several embodiments generally relate to generating an irrigation schedule for input to an irrigation controller. In one embodiment, the invention can be characterized as an apparatus for creating an irrigation schedule for an area to be irrigated, the area having a plurality of characteristics, comprising a computer readable medium storing a set of instructions. The apparatus also includes a processor coupled to the computer readable medium and adapted to execute the set of instructions to: cause the display of a graphical user interface comprising a plurality of sets of user selectable graphic images, each set of user selectable graphic images corresponding to a characteristic of the area, and each set having user selectable graphic images corresponding to different properties of the characteristic; and generate the irrigation schedule in response to user selection of at least one user selectable graphic image from each of the plurality of sets.

In another embodiment, the invention can be characterized as an apparatus for creating an irrigation schedule for an area to be irrigated, the area having a plurality of characteristics, comprising a computer readable medium storing a set of instructions adapted to be executed by a processor coupled to the computer readable medium. The set of instructions, when executed, are adapted to: cause the display of a graphical user interface comprising a plurality of sets of user selectable graphic images, each set of user selectable graphic images corresponding to a characteristic of the area, and each set having user selectable graphic images corresponding to different properties of the characteristic; and generate the irrigation schedule in response to user selection of at least one user selectable graphic image from each of the plurality of sets.

In another embodiment, the invention can be characterized as a method of creating an irrigation schedule for an area to be irrigated, the area having a plurality of characteristics, comprising: displaying a graphical user interface comprising a plurality of sets of user selectable graphic images, each set of user selectable graphic images corresponding to a characteristic of the area, and each set having user selectable graphic images corresponding to different properties of the characteristic; and generating the irrigation schedule in response to user selection of at least one user selectable graphic image from each of the plurality of sets.

In another embodiment, the invention can be characterized as a method for creating an irrigation schedule for an area to be irrigated, the area having at least one zone, comprising: selecting, at a user interface, at least one user selectable graphic image from a plurality of sets of user selectable graphic images corresponding to two or more of the following characteristics of the at least one zone: plant type; sun exposure for the plant type; plant density; slope; soil type; and sprinkler type. The method further comprises causing the irrigation schedule to be generated and inputting the irrigation schedule having been generated into a separate controller.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a block diagram illustrating a processor based system that may be used to run, implement and/or execute the methods and/or techniques shown and described herein in accordance with embodiments of the invention.

FIG. 2 is a flowchart illustrating a method of generating an irrigation schedule in accordance with several embodiments.

FIG. 3 is a flowchart illustrating a method of generating an irrigation schedule using one or more user selected graphic images in accordance with several embodiments.

FIG. 4 is an exemplary portion of a graphical user interface for creating an irrigation schedule or returning to an irrigation schedule in accordance with various embodiments.

FIG. 5 is an exemplary portion of a graphical user interface that provides user selectable images for generating an irrigation schedule in accordance with one embodiment.

FIG. 6 is an exemplary portion of a graphical user interface that provides user selectable images for generating an irrigation schedule for a first zone in accordance with one embodiment.

FIG. 7 is an exemplary portion of a graphical user interface that provides user selectable images for generating an irrigation schedule for a second zone in accordance with one embodiment.

FIG. 8 is an exemplary portion of a graphical user interface that provides supplemental information regarding a selectable property of a characteristic of a zone in accordance with one embodiment.

FIG. 9 is an exemplary portion of a graphical user interface that displays a generated irrigation schedule in accordance with various embodiments.

FIG. 10 is a diagram illustrating various ways in which an irrigation schedule is provided to an irrigation controller.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of the embodiments of the invention. The scope of the embodiments should be determined with reference to the claims. The present embodiments address the problems described in the background while also addressing other additional problems as will be seen from the following detailed description. It is noted that, as used in this specification and the appended claims, the singular forms “a,” “an,” and “the” include plural referents unless the context clearly dictates otherwise. As used herein, “comprising,” “including,” “containing,” “characterized by,” and grammatical equivalents thereof are inclusive or open-ended terms that do not exclude additional, unrecited elements or method steps.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, hardware modules, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

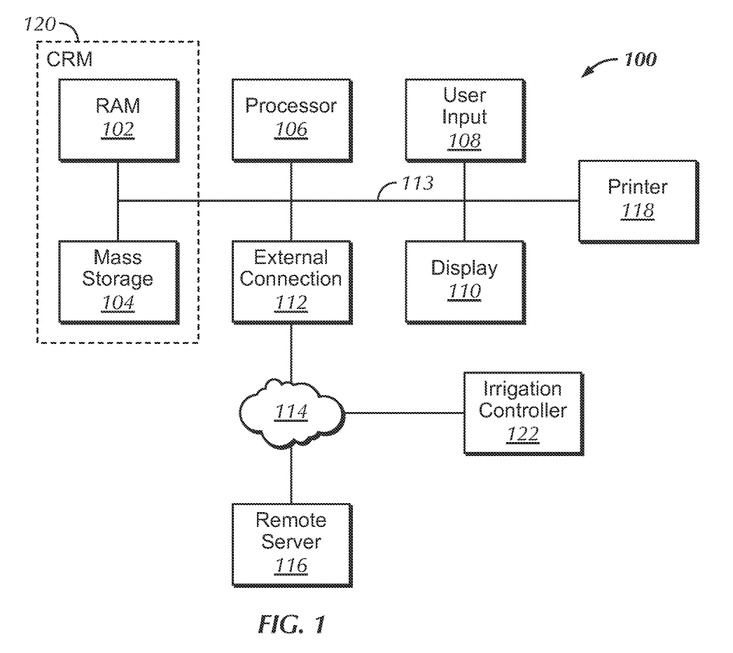

Referring to FIG. 1, a block diagram is shown illustrating a processor based system 100 for use in generating an irrigation schedule in accordance with one embodiment. The processor based system 100 includes a random access memory (RAM) 102, mass storage 104, a processor 106, user input 108, a display 110, an external connection 112, and a printer 118 all coupled together with bus 113. The system 100 also includes a remote server 116 and an irrigation controller 122 coupled to the external connection 112 by network 114. In some embodiments, the RAM 102 and the mass storage 104 may be referred to collectively as a computer readable medium (CRM) 120.

According to several embodiments, the computer readable medium 120 is coupled with the processor 106 so that the processor 106 is able to execute programs stored within the computer readable medium 120. The user input 108 is coupled with the processor 106 and to the computer readable medium 120 to allow a user to interact with the processor based system 100. The display 110 is coupled with the user input 108, the processor 106, and the computer readable medium 120. The external connection 112 is coupled to the remote server 116 and the irrigation controller 122 via the network 114. The external connection 112 is also coupled to the computer readable medium 120 and the processor 106. In some embodiments, a printer 118 is coupled to the computer readable medium 120, the processor 106, the user input 108, and the display 110.

According to several embodiments, processor based system 100 is adapted to generate an irrigation schedule using a set of instructions stored in the computer readable medium 120. In some embodiments, the computer readable medium 120, the processor 106, and the external connection 112 may be a basic general purpose computer, e.g., personal computer (PC), or any other type of computing platform owned and operated by a user. In other embodiments, the computer readable medium 120, the processor 106, the user input 108, the display 110, and the external connection 112 may be a basic general purpose computer, e.g., a laptop, or any other type of computing platform owned and operated by a user. In some embodiments, the set of instructions may be an executable program. The set of instructions may be stored in RAM 102, in mass storage 104, or in both. In some embodiments, the set of instructions is received by the external connection 112 from the remote server 116 via the network 114. The network 114 may be any type of network, including, but not limited to a wired network, a wireless network, a Bluetooth network, a wide area network (WAN), a local area network LAN, a broadband network, etc. In other embodiments, the set of instructions may be input by a user using a physical medium (not shown), for example, a compact disk (CD-ROM), a DVD, a flash drive, etc. In some embodiments, the processor 106 executes the set of instructions in response to input by a user via user input 108. User input 108 can be any type of device that allows a user to interact with the processor based system 100, e.g., a keyboard, a keypad, a mouse, a remote controller, a touchscreen, etc. In other embodiments, the processor 106 may execute the set of instructions in response to a system start-up. Upon execution of the set of instructions by the processor 106, a graphical user interface is presented on the display 110. The display 110 may be any type of display, e.g. LCD, LED, plasma, etc.

In accordance with several embodiments, the graphical user interface comprises multiple sets of user selectable graphic images corresponding to different characteristics of an area to be irrigated. The sets of user selectable graphic images make it simple for an unsophisticated user to create an irrigation schedule. Each user selectable graphic image within the sets of user selectable graphic images has an illustration, e.g., a picture, for assisting an unsophisticated user in selecting an appropriate property of the characteristic for an area to be irrigated. It is understood that the illustration may be any type of illustration, e.g., a picture, a graphic image, a drawing, an avatar, etc. The user will pick the illustration that most closely resembles the property of the area to be irrigated for that particular characteristic in order to easily create an irrigation schedule. Several embodiments of the graphical user interface and irrigation schedule will be described in greater detail below.

The user interacts with the graphical user interface by issuing commands via user input 108 and an irrigation schedule is generated based on the user inputs. The irrigation schedule is displayed on the display 110 and, in some embodiments, may be saved in the computer readable medium 120. In other embodiments, the irrigation schedule may be sent to the printer 118 for printing. Further, in some embodiments, a user may manually input the irrigation schedule into the irrigation controller 122. In other embodiments, the irrigation schedule may be transferred or directly input into the irrigation controller 122.

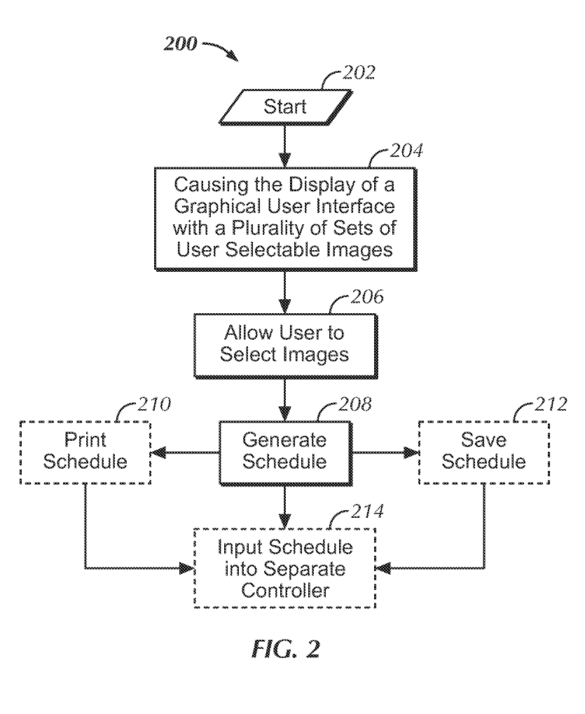

Referring next to FIG. 2, a flowchart 200 is shown that illustrates a method of generating an irrigation schedule in accordance with several embodiments. The steps may be performed by any number of systems or structures, including those described herein, e.g., by the processor based system 100.

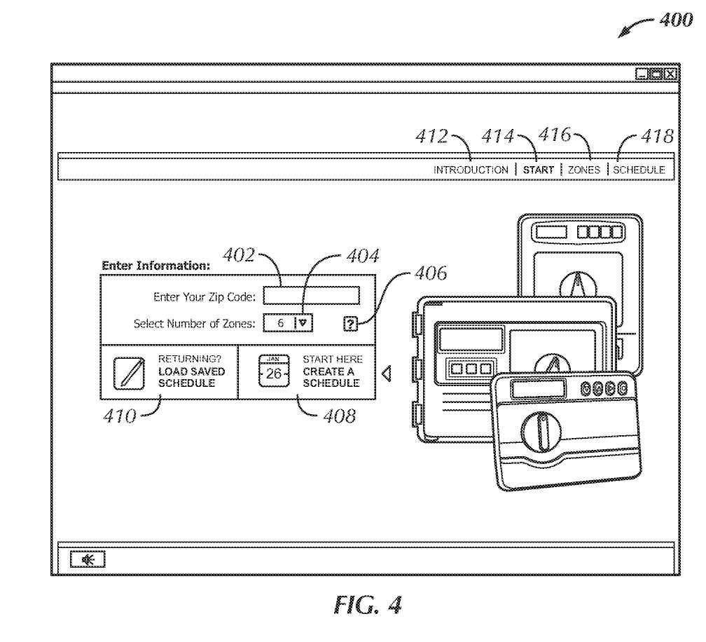

Initially, a set of instructions is executed to start a program (Step 202), e.g., in response to user input or in response to system start-up. For example, in several embodiments, a user may initiate the start of an irrigation schedule generation program by selecting an appropriate icon or other item representing the program on the user's display. In other embodiments, the program may be configured to start upon a computer system start-up, e.g. when a user turns a computer on. Next, a graphical user interface is displayed (Step 204), e.g., the processor 106 executes the set of instructions to cause the display of the graphical user interface. The graphical user interface, for example, includes a plurality of sets of user selectable graphic images corresponding to different characteristics of each zone within an area to be irrigated, e.g., plant type, plant density, etc. The images within each set of user selectable graphic images correspond to different properties of the characteristic, e.g., warm grass, trees, etc. A more detailed description regarding the graphical user interface will be discussed in accordance with FIGS. 4-8.

The images are user selectable so that a user may specify which images most closely correspond to the properties of the zone in the user's desired irrigation area. Next, the program allows a user to select the images that correspond to each zone (Step 206). In some embodiments, the user can choose the images that most closely resemble the property of the characteristic of zone and does not need extensive knowledge of the properties of the landscape in the zone. The images may include, for example, different selectable illustrations for each of plant types, sun exposures, plant density, slope, soil type, sprinklers, etc. A more detailed description of the graphical user interface will be described in accordance with FIG. 4-8.

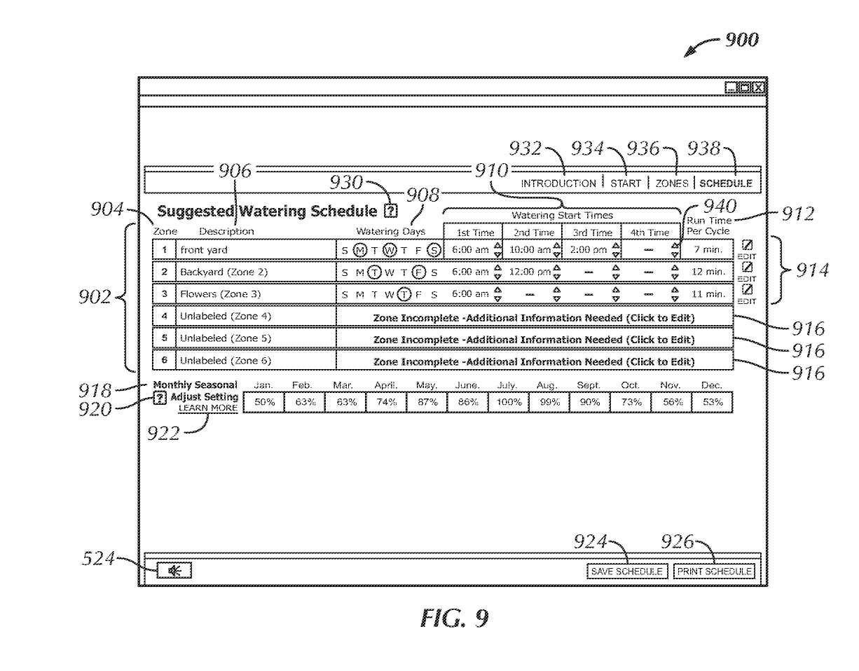

Next, an irrigation schedule is generated based on the selected images (Step 208). The irrigation schedule is displayed for the user to view. A more detailed description of one embodiment of the irrigation schedule will be described in accordance with FIG. 9. Next, in several embodiments, the user has the option to either print the irrigation schedule (Step 210) or to save the irrigation schedule (Step 212). Once the user has either printed or saved the irrigation schedule, the user may manually input the irrigation schedule into a separate irrigation controller (Step 214), e.g., using a user interface of the irrigation controller 122. In other embodiments, the user may directly enter or transfer the irrigation schedule into a separate irrigation controller from the platform running the program (Step 214), e.g., the irrigation schedule may be directly entered or transferred over network 114 to irrigation controller 122.

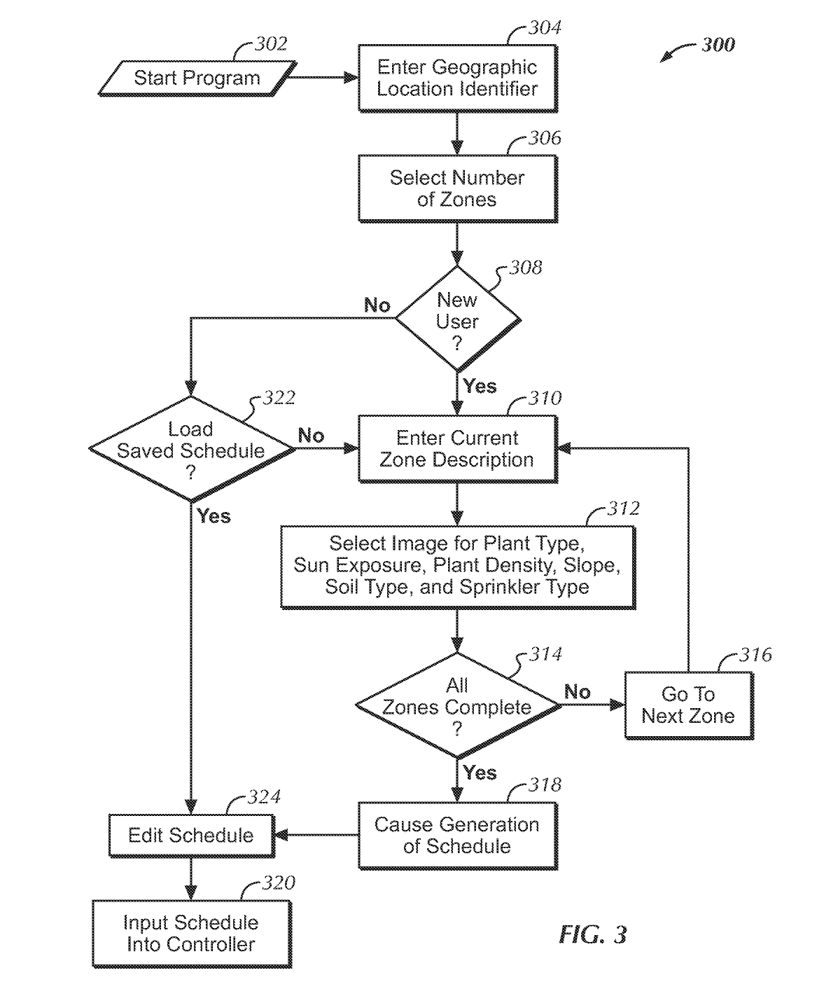

Referring next to FIG. 3, a flowchart 300 is shown that illustrates a method of generating an irrigation schedule using one or more user selected graphic images in accordance with several embodiments. The steps may be performed, for example, by a user interacting with the processor based system 100, but may be performed by a user interacting with any number of systems or structures.

Initially, a program for generating an irrigation schedule is started by a user initiating the execution of a set of instructions (Step 302). The program may be started, e.g., in response to user input or in response to system start-up as described above in accordance with FIG. 2. Upon execution of the set of instructions, a graphical user interface is displayed (not shown). In some embodiments, the graphical user interface, when initially displayed, presents an introduction to the user. For example, the introduction may present the user with the advantages of the program in creating irrigation schedules. The introduction may also explain how the program calculates an optimal irrigation schedule. As one example, a combination of factors that the program analyzes may be explained to the user. As another example, the introduction may explain to the user how landscape areas are divided into irrigation zones, and what is contained within the irrigation zone. The introduction may also illustrate how the zones may be laid out in the area to be irrigated as well as display corresponding text descriptions. Also, for example, the introduction may explain how certain characteristics of the area to be irrigated affect the outcome of the custom irrigation schedules. In some embodiments, the introduction assists a non-sophisticated irrigation user. The user may decide to skip the introduction by selecting an appropriate command, e.g. by selecting an icon.

Next, the user enters a geographic location identifier corresponding to the user's geographic location (Step 304). In some embodiments, the geographic location identifier may allow the program to determine an irrigation schedule and/or seasonal adjust values for that geographic location. In some embodiments, information corresponding to the geographic location may be stored as a database embedded in the program (e.g., an application program). For example, the information may be the monthly average ET value for all twelve months of the year. From this, seasonal adjust values for each month of the year relative to a maximum can be generated as a ratio of the monthly average to the maximum. For example, in one embodiment, the peak monthly average ET value is used as the denominator in all of the ratios for calculating seasonal adjust values for each month, while each month's average ET value is used as the numerator in the seasonal adjust value calculation for that month. Thus, in this one example embodiment, the seasonal adjust value for the peak month will be 100% (i.e. no change needed to the irrigation schedule) and the seasonal adjust value for the other eleven months will be a fraction of the peak. The geographic location identifier may be, for example, a zip code, an address, latitudinal and longitudinal coordinates, etc. In some embodiments, each zip code has its own information.

Next, the user selects the number of zones that are present in the area that is to be irrigated (Step 306). In some embodiments, the user may be provided with supplemental information as to how to determine the number of zones that are in the area, e.g., in response to the user selecting an information icon. For example, the supplemental information may inform the user to count the number of valves to determine the number of zones in the area.

Next, the program determines if the user is a new user or a returning user (Step 308). The program allows a returning user to select an option allowing the user to load a saved irrigation schedule (Step 322). The returning user may edit the loaded saved irrigation schedule (Step 324). The returning user may also select an option that allows the user to create a new schedule, e.g., by selecting a new schedule option. If the user is a new user, then the program does not provide the option of returning to a saved schedule, and the user may choose to create a new irrigation schedule.

In some embodiments, the program may allow the user to select an option to return to the introduction. Further, in some embodiments, the program may allow the user to mute or allow audio explaining the steps or providing supplemental information as the user navigates throughout the graphical user interface, e.g. by selecting an appropriate icon.

Next, if a new or returning user decides to create a new schedule, the user selects the new schedule option and the program displays a new page or screen of the graphical user interface allowing the user to enter information regarding a first zone within the area to be irrigated. In some embodiments, the user enters a description of the first zone in a text box (Step 310). For example, the user may enter a textual description describing the zone as front yard grass or back yard flowers. In some embodiments, the user may decide not to enter a zone description. In the event the user decides not to enter a zone description, the program may automatically enter a zone description using a generic label, e.g. Untitled, zone number, etc. Next, the program prompts the user to select at least one graphic image from each of multiple sets of user selectable graphic images, each set corresponding to a characteristic or category of the zone (Step 312). For example, the user may select a graphic image corresponding to plant type, amount of sun exposure, plant density, slope, soil type, and sprinkler type. Each graphic image within the set of images corresponds to a different property of the characteristic or category of the zone. In some embodiments, the graphic images may be photographic images or any other visual illustrations, e.g., a picture, a graphical representation, a drawing, an avatar, a visual indicator, etc. Further, in some embodiments, the user selects the image that most closely looks like the landscape of the first zone within the area to be irrigated. A more detailed discussion of the graphical user interface will be described below in accordance with FIGS. 4-8.

Once the user has selected an image for each characteristic of the zone, the program determines whether all zones have been completed (Step 314). If all the zones have not been completed the program allows the user to go to a next zone (Step 316), where the user may enter the current zone description (Step 310) or leave the zone description blank where the program will provide a generic description. The user will then select images from the multiple sets of images corresponding to various characteristics or categories of the current zone (Step 312). In some embodiments, the user may skip to a desired zone prior to completing the currently viewed zone, e.g. by selecting an icon representing the desired zone. In some embodiments, if a graphic image is not selected from each of the sets of user selectable graphic images in a particular zone, then the zone will be incomplete and a schedule will not be generated for that zone. The user may then return to a zone at any time by selecting an appropriate icon.

Next, once all the zones have been completed, the program automatically generates an irrigation schedule for the entire area (Step 318) in response to the user's selection of images for each zone and appropriate icons, e.g., a schedule icon. In some embodiments, the user may skip to the irrigation schedule prior to completing all the zones, where the zones that have not been completed may display the zone as incomplete in the schedule. A more detailed discussion of the irrigation schedule will be described below in accordance with FIG. 9. The irrigation schedule generated by the program is displayed for the user to view. In some embodiments, the user may print the irrigation schedule. In some embodiments, the user may save the irrigation schedule in a storage medium, e.g. RAM, a flash drive, etc. Next, the user may edit a loaded saved irrigation schedule or may edit the new irrigation schedule (Step 324).

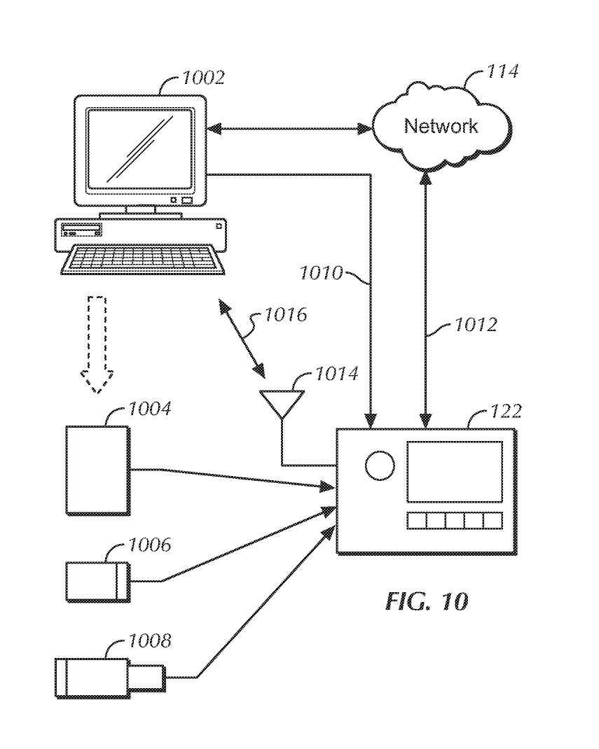

Next, the user may input the irrigation schedule into a separate irrigation controller (Step 320). For example, the user may take a printed irrigation schedule and manually input the schedule into the irrigation controller using a user interface of the controller. In some embodiments, the user may have the program input or transfer the irrigation schedule directly into a separate irrigation controller. For example, the program may input or transfer the irrigation schedule directly into a separate irrigation controller using a direct computer to controller connection, using an Internet connection, a wireless connection, or any other suitable means. In other embodiments, the user may input or transfer the irrigation controller into a separate irrigation controller using transportable electronic storage media (e.g., USB storage device, SD Card, etc.). A more detailed discussion of various ways of inputting or transferring an irrigation schedule into a separate irrigation controller will be described below in accordance with FIG. 10.

Referring next to FIG. 4, a graphical user interface 400 is shown for generating an irrigation schedule. The graphical user interface 400 includes a region 402 for a user to enter a geographic location identifier, a region 404 for a user to select a number of zones, Information icon 406, Create a Schedule option 408, Load Saved Schedule option 410, Introduction option 412, Start option 414, Zones option 416, and Schedule option 418. In the illustrated embodiment, the graphical user interface 400 simultaneously displays all elements.

According to several embodiments, graphical user interface 400 is adapted to allow a user to either create a new irrigation schedule or to return to a saved schedule. Region 402 allows a user to enter a geographic location identifier that corresponds to the geographic region in which the user wishes to irrigate. In some embodiments, the geographic location identifier may allow the program to determine an irrigation schedule and/or seasonal adjust values for that geographic location. The geographic location identifier may be, for example, a zip code, an address, latitudinal and longitudinal coordinates, etc. Region 404 allows the user to specify the number of zones that are within the area to be irrigated. In some embodiments, the number of zones corresponds to the number of valves that are in the area. Region 402 and region 404 may be generically referred to as input region 402 and input region 404, respectively. Further, in some embodiments, the user may select Information icon 406 in order to receive supplemental information regarding how to determine the number of zones in the area, e.g. the graphical user interface will display a dialog box indicating that the number of zones corresponds to the number of valves in the area. Information icon 406 may be generically referred to as a user selectable icon.

Once the user has entered the zip code in region 402 and the number of zones in region 404, the graphical user interface 400 allows the user to create a new schedule by allowing the user to select Create a Schedule option 408. If the user is a returning user and has saved a previously generated schedule, the graphical user interface 400 allows the user to return to a saved schedule by allowing the user to select Load Saved Schedule option 410. In some embodiments, if the user is not a returning user then the Load Saved Schedule option 410 will be unselectable, e.g. Load Saved Schedule option 410 will be displayed in a way that prevents a user from selecting it. For example, as illustrated, the option is faded or unhighlighted indicating it is not selectable. Further, in some embodiments, if a user selects the Create a Schedule option 408 but has failed to enter a zip code in region 402, or a number of zones in region 404, then the graphical user interface 400 prompts the user to enter the zip code in region 402, or the number of zones in region 404.

A user may select Introduction option 412 to cause the graphical user interface 400 to display the introduction, which is an introduction to the irrigation scheduler program. The introduction is described in further detail above in accordance with FIG. 3. Start option 414 allows the user to return at any time to graphical user interface 400 in order to create a new schedule or return to a saved schedule. In some embodiments, Zones option 416 and a Schedule option 418 are unselectable by a user while the user is viewing graphical user interface 400.

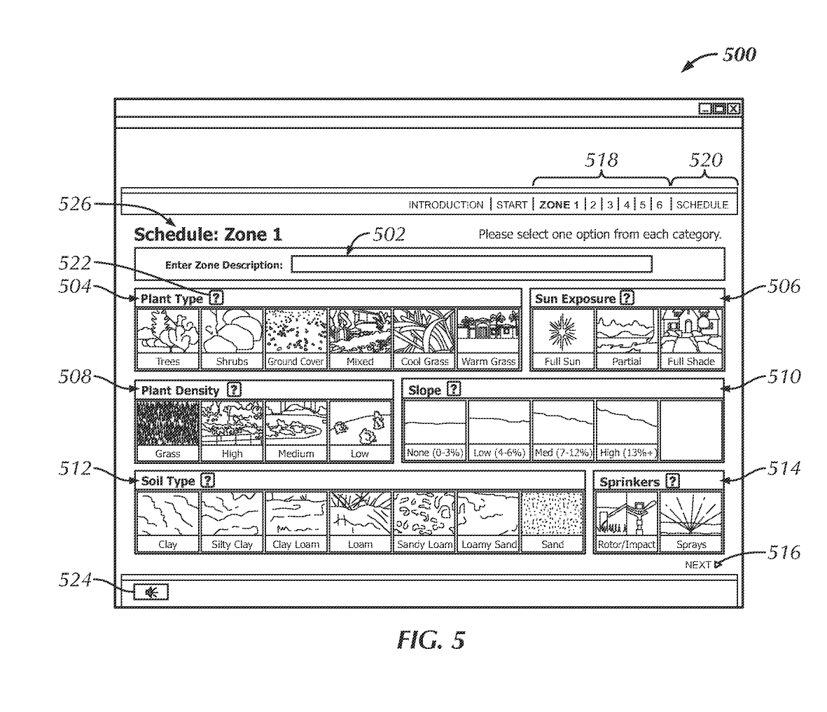

Referring next to FIG. 5, an example of a graphical user interface 500 is shown for generating an irrigation schedule. The graphical user interface 500 includes Zone Description region 502, Plant Type selection region 504, Sun Exposure selection region 506, Plant Density selection region 508, Slope selection region 510, Soil Type selection region 512, Sprinklers Type selection region 514, Next icon 516, Zone options 518, Schedule option 520, Information icon 522, Audio icon 524, and Zone indicator 526. In the illustrated embodiment, graphical user interface 500 simultaneously displays all elements. It is understood that these elements may be displayed on multiple graphical user interfaces or screens.

According to several embodiments, graphical user interface 500 is adapted to allow a user to enter a description of a zone, e.g. zone 1, and select graphic images from a plurality of sets of user selectable graphic images that correspond to characteristics of the zone in order to create an irrigation schedule. The graphic images within each set of user selectable graphic images correspond to different properties of the characteristics. In some embodiments, the user selectable graphic images may be photographic images or any other visual illustrations, e.g., a picture, a graphical representation, a drawing, an avatar, a visual indicator, etc. By allowing a user to select the images that most closely resemble the landscape of the zone within the area to be irrigated, the user does not need to have knowledge of irrigation systems.

Zone indicator 526 indicates the current zone for which the user is creating a schedule. Zone Description region 502 allows a user to enter a description of the zone the user is currently creating a schedule for, e.g. the user may enter a description describing the zone as front yard grass. Zone description region 502 may be generically referred to as input region 502. In some embodiments, if the user fails to enter a zone description in Zone Description region 502, graphical user interface 500 will automatically enter a zone description using a generic label, e.g. Untitled, Zone 1, etc.

A set of user selectable graphic images that correspond to a characteristic of an area, e.g., Plant Type selection region 504, comprises a plurality of images and text descriptions describing the images. Each image within Plant Type selection region 504 corresponds to a different plant type that may be present in the zone that the user is creating a schedule for. The plant types may include, but are not limited to, Trees, Shrubs, Ground Cover, Mixed, Cool Grass, and Warm Grass. A user may select one of the images to specify the type of plants that are present in the zone. For example, the user may select the Mixed image to specify that the zone is comprised of mixed plant types.

A set of user selectable graphic images that correspond to a characteristic of an area, e.g., Sun Exposure selection region 506, comprises a plurality of images and text descriptions describing the images. Each image within Sun Exposure selection region 506 corresponds to a different amount of sun exposure that may be present in the zone that the user is creating a schedule for. The amounts of sun exposure may include, but are not limited to, Full Sun, Partial Sun, and Full Shade. A user may select one of the images to specify the amount of sun exposure that the zone receives. For example, the user may select the Full Sun image to specify that the zone receives full sun exposure.

A set of user selectable graphic images that correspond to a characteristic of an area, e.g. Plant Density selection region 508, comprises a plurality of images and text descriptions describing the images. Each image within Plant Density selection region 508 corresponds to a different plant density that may be present in the zone that the user is creating a schedule for. The different plant densities may include, but are not limited to, Grass, High Density, Medium Density, and Low Density. A user may select one of the images to specify the plant density that is present in the zone. For example, the user may select the High Density image to specify that the zone is highly densely populated.

A set of user selectable graphic images that correspond to a characteristic of an area, e.g., Slope selection region 510, comprises a plurality of images and text descriptions describing the images. Each image within Slope selection region 510 corresponds to a different grade of slope that may be present in the zone that the user is creating a schedule for. The different slopes may include, but are not limited to, None (0-3%), Low (4-6%), Med (7-12%), and High (13%+). The percentage of slope may change according to the preference of the user, e.g. None (0-3%) may be modified to be None (0-5%). A user may select one of the images to specify the slope grade that is present in the zone. For example, the user may select the Med (7-12%) image to specify that the zone has a medium slope.

A set of user selectable graphic images that correspond to a characteristic of an area, e.g., Soil Type selection region 512, comprises a plurality of images and text descriptions describing the images. Each image within Soil Type selection region 512 corresponds to a different soil type that may be present in the zone that the user is creating a schedule for. The different soil types may include, but are not limited to, Clay, Silty Clay, Clay Loam, Loam, Sandy Loam, Loamy Sand, and Sand. A user may select one of the images to specify the soil type that is present in the zone. For example, the user may select the Clay image to specify that clay is the type of soil in the zone.

A set of user selectable graphic images that correspond to a characteristic of an area, e.g., Sprinklers Type selection region 514, comprises a plurality of images and text descriptions describing the images. Each image within Sprinklers Type selection region 514 corresponds to a different sprinkler type that may be present in the zone that the user is creating a schedule for. The different sprinkler types may include, but are not limited to, Rotor, Impact, and Sprays. A user may select one of the images to specify the sprinkler type that is present in the zone. For example, the user may select the Sprays image to specify that the sprinklers in the zone are spray-type sprinklers.

In some embodiments, when the user moves a cursor over an image, the image may become highlighted, e.g. the image becomes brighter in color than the non-highlighted images, until the user moves the cursor from the image. Further, in some embodiments, when the user selects the desired image, the image may remain highlighted until a different image is selected.

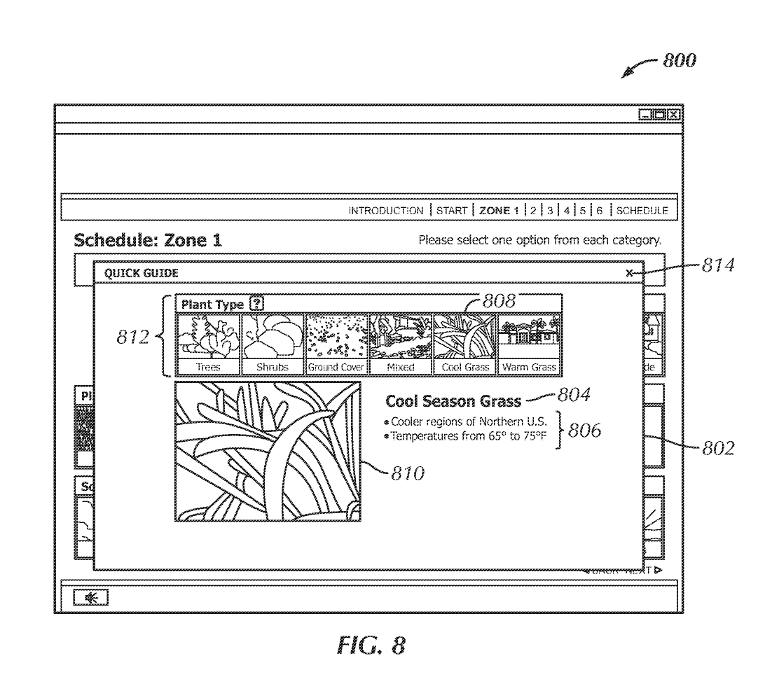

The user may select an information icon, such as Information icon 522, in order to receive supplemental information regarding the different properties displayed in the images. Information icon 522 may be generically referred to as a user selectable icon. The user may also select Audio icon 524 to turn audio on or off. In some embodiments, a user may select an information icon, e.g. Information icon 522, and if the Audio icon 524 is selected to turn the audio on, the supplemental information will be accompanied by audio (e.g., sounds, music, and/or voice instructions/explanations). A more detailed discussion of supplemental information regarding the different characteristics of the zones, e.g. plant type, will be described below in accordance with FIG. 8.

When the user is finished selecting images from the plurality of user selectable images corresponding to characteristics of the zone, the user may select Next icon 516 in order to advance to the next zone. In some embodiments, the user may select from Zone options 518 in order to advance to a desired zone. Further, if a user desires to go directly to the irrigation schedule, the user may select Schedule option 520. In some embodiments, if any of the zones have not been completed prior to the user selecting Schedule option 520, then the zone will be incomplete in the irrigation schedule.

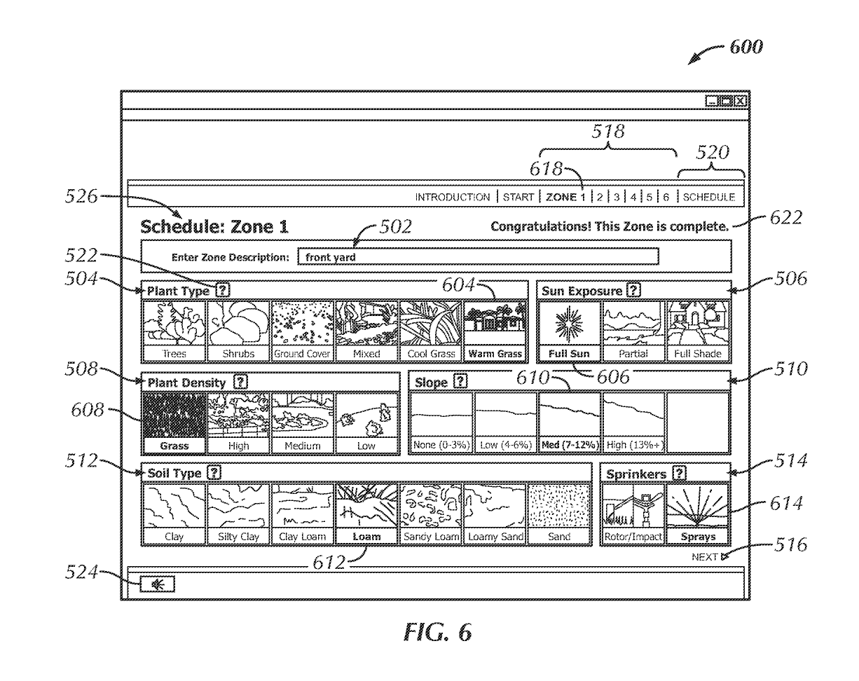

Referring next to FIG. 6, an example of a graphical user interface of FIG. 5 is shown for which a user has selected images corresponding to characteristics of a first zone. Relative to FIG. 5, the graphical user interface 600 additionally includes Warm Grass image 604, Full Sun image 606, Grass image 608, Med (7-12%) slope image 610, Loam image 612, Sprays image 614, Zone 1 option 618, and Zone Complete indicator 622. In the illustrated embodiment, graphical user interface 600 simultaneously displays all elements. It is understood that these elements may be displayed on multiple graphical user interfaces or screens.

According to several embodiments, graphical user interface 600 is adapted to allow a user to enter a description of a first zone, e.g. zone 1, and select images from a plurality of user selectable images that correspond to characteristics of the first zone in order to create an irrigation schedule. In some embodiments, the user selectable images may be user selectable graphic images. Further, in some embodiments, the user selectable graphic images may be photographic images or any other visual illustrations, e.g., a picture, a graphical representation, a drawing, an avatar, a visual indicator, etc.

Zone 1 option 618 is highlighted to display to the user which zone is currently being scheduled. Zone Description region 502 allows a user to enter a description of the zone the user is currently creating a schedule for, e.g. the user has entered “front yard” as the description of the first zone. In some embodiments, if the user fails to enter a zone description in Zone Description region 502, graphical user interface 600 will automatically enter a zone description using a generic label, e.g. Untitled, Zone 1.

Graphical user interface 600 is an example of a user's selection of graphic images from a plurality of sets of user selectable graphic images corresponding to characteristics of a first zone. For instance, the user has selected the Warm Grass image 604 within the Plant Type selection region 504, the Full Sun image 606 within the Sun Exposure selection region 506, the Grass image 608 within the Plant Density selection region 508, the Med (7-12%) slope image 610 within the Slope selection region 510, the Loam image 612 within the Soil Type selection region 512, and the Sprays image 614 within the Sprinklers Type selection region 514. The irrigation scheduler program will generate a schedule for the first zone based on the images selected by the user. Once the user has selected at least one image from each selection region, the Zone Complete indicator 622 is displayed informing the user that the first zone has been completed.

When the user is finished selecting images from each of the selection regions, the user may select Next icon 516 in order to advance to the next zone. In some embodiments, the user may select from Zone options 518 in order to advance to a desired zone. Further, if a user desires to go directly to the irrigation schedule, the user may select Schedule option 520.

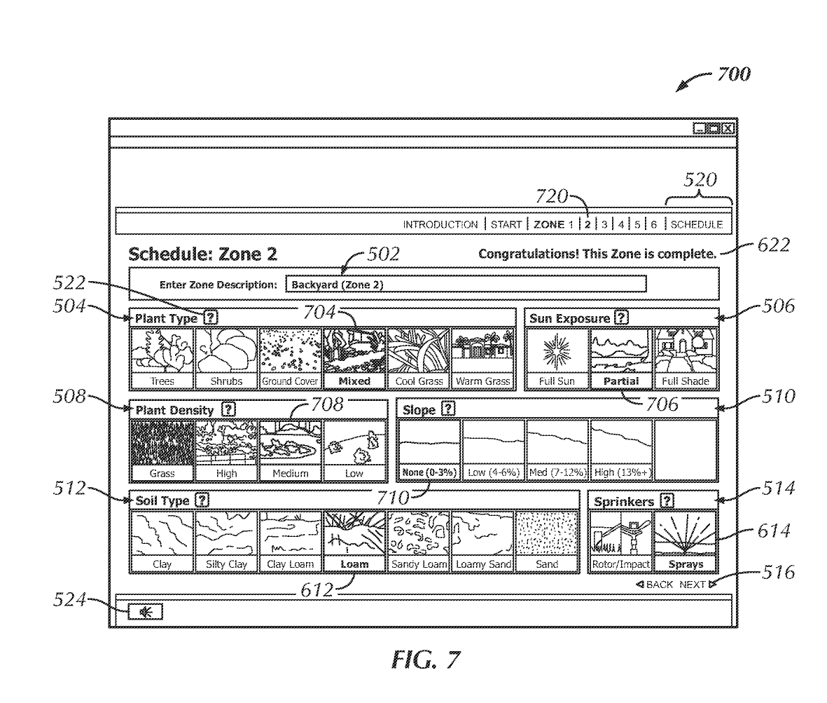

Referring next to FIG. 7, an example of a graphical user interface of FIG. 5 is shown for which a user has selected images corresponding to characteristics of a second zone. The graphical user interface 700 includes Mixed image 704, Partial image 706, Medium image 708, None (0-3%) slope image 710, Loam image 612, Sprays image 614, Back icon 716, Next icon 516, Zone 2 option 720, Schedule option 520, Information icon 522, and Zone Complete indicator 622. In the illustrated embodiment, graphical user interface 700 simultaneously displays all elements. It is understood that these elements may be displayed on multiple graphical user interfaces or screens.

According to several embodiments, graphical user interface 700 is adapted to allow a user to enter a description of a second zone, e.g. zone 2, and select images from a plurality of user selectable images that correspond to characteristics of the second zone in order to create an irrigation schedule. In some embodiments, the user selectable images may be user selectable graphic images. Further, in some embodiments, the user selectable graphic images may be photographic images or any other visual illustrations, e.g., a picture, a graphical representation, a drawing, an avatar, a visual indicator, etc. In one embodiment, graphical user interface 700 is displayed after the user selects Next icon 516 in FIG. 6.

Zone 2 option 720 is highlighted to display to the user which zone is currently being scheduled. Zone Description region 502 allows a user to enter a description of the zone the user is currently creating a schedule for, e.g. the user has entered “backyard (Zone 2)” as the description of the first zone. In some embodiments, if the user fails to enter a zone description in Zone Description region 502, graphical user interface 700 will automatically enter a zone description using a generic label.

Graphical user interface 700 is an example of a user's selection of graphic images from a plurality of sets of user selectable graphic images corresponding to characteristics of a second zone. For instance, the user has selected the Mixed image 704 within the Plant Type selection region 504, the Partial image 706 within the Sun Exposure selection region 506, the Medium image 708 within the Plant Density selection region 508, the None (0-3%) slope image 710 within the Slope selection region 510, the Loam image 712 within the Soil Type selection region 512, and the Sprays image 714 within the Sprinklers Type selection region 514. The irrigation scheduler program will generate a schedule for the first and second zones based on the images selected by the user. Once the user has selected at least one image from each selection region, the Zone Complete indicator 622 is displayed informing the user that the second zone has been completed.

When the user is finished selecting images from each of the selection regions, the user may select Next icon 516 in order to advance to the next zone. In some embodiments, if the zone for which images are currently being selected is the last zone in the area to be irrigated, the Next icon 516 may be replaced with a Schedule icon, which when selected will take the user directly to the irrigation schedule. The user may also select the Back icon 716 if the user wishes to go to the previous zone, e.g., Zone 1. If a user desires to go directly to the irrigation schedule, the user may select Schedule option 520. Further, a user may select Information icon 522 to receive supplemental information regarding the different properties within each of the selection regions. Information icon 522 may be generically referred to as a user selectable icon.

Referring next to FIG. 8, an example of a Supplemental Information page 802 within graphical user interface 800 is shown for supplying a user with supplemental information regarding the images within each of the plurality of selection regions. The graphical user interface 800 includes Supplemental Information page 802, Detailed Property Title 804, Detailed Property Description 806, Highlighted Property 808, Enlarged Property Image 810, Plant Type selection region 812, and Exit icon 814. Graphical user interface 800 simultaneously displays all elements.

According to several embodiments, graphical user interface 800 is adapted to display to a user supplemental information describing in detail what properties each image corresponds to in order to make it easier for the user to make a selection. Supplemental Information page 802 within graphical user interface 800 is displayed in response to a user selecting an information icon, e.g. Information icon 522 of FIG. 7. Supplemental Information page 802 displays detailed supplemental information about each of the images within Plant Type selection region 812. In some embodiments, the images include Trees, Shrubs, Ground Cover, Mixed, Cool Grass, and Warm Grass. An example is shown in Supplemental Information page 802 of providing the user with detailed supplemental information regarding the Highlighted Property 808, e.g. Cool Grass. The detailed supplemental information includes Detailed Property Title 804, Detailed Property Description 806, and Enlarged Property Image 810. Detailed Property Title 804 may provide a more detailed title for the user. Detailed Property Description 806 provides supplemental information about the property the image corresponds to in order to help the user understand the different properties more clearly. For example, Detailed Property Description 806 may explain that Cool Season Grass is present in cooler regions of the Northern U.S. and in temperatures ranging from 65 to 75 degrees. Enlarged Property Image 810 provides the user with a larger image that relates to the property currently being described, e.g. a close-up image of grass corresponding to the Cool Grass property. In some embodiments, Supplemental Information page 802 will automatically close when the graphical user interface 800 is finished describing the different properties within the selection region. Further, in some embodiments, the user may select Exit icon 814 if the user desires to close Supplemental Information page 802 at any time.

Referring next to FIG. 9, an example of a graphical user interface 900 is shown that displays a generated irrigation schedule. The graphical user interface 900 includes Suggested Watering Schedule 902, Zone number 904, Description 906, Watering Days 908, Watering Start Times 910, Run Time Per Cycle 912, Edit icons 914, Zone Incomplete options 916, Monthly Seasonal Adjust Setting 918, Information icon 920, Learn More option 922, Save Schedule option 924, Print Schedule option 926, Audio icon 524, Information icon 930, Introduction option 932, Start option 934, Zones option 936, Schedule option 938, and Start Time Adjust arrow 940. Graphical user interface 900 simultaneously displays all elements.

According to several embodiments, graphical user interface 900 is adapted to display an irrigation schedule. The irrigation schedule is generated according to user-selected images corresponding to different properties of various characteristics of each zone within an area to be irrigated. Suggested Watering Schedule 902 displays a suggested watering schedule for each zone. Suggested Watering Schedule 902 includes at least Zone number 904, Description 906, Watering Days 908, Watering Start Times 910, Run Time Per Cycle 912, and Monthly Seasonal Adjust Setting 918.

Zone number 904 displays a number for each zone. Description 906 displays a description for each zone. Description 906 corresponds to descriptions the user entered in the Zone Description regions for each zone, e.g. Zone Description region 502 of FIG. 5. In some embodiments, if a user fails to provide a zone description for a zone, the zone is labeled with a generic description. In some embodiments, a user may manually adjust a description for a particular zone. For example, the user may click on the description the user wants to change and type in the desired description. Watering Days 908 displays an indicator, e.g. a circle, around the days in which irrigation is to occur. For example, the Suggested Watering Schedule 902 may indicate that watering is to occur on Monday, Wednesday, and Saturday of each week. In some embodiments, a user may drag and drop an indicator to a different day in order to alter the irrigation schedule.

Watering Start Times 910 displays the times for which irrigation will begin throughout the Watering Days 908. Watering Start Times 910 will vary depending on the properties within each zone. Run Time Per Cycle 912 displays the duration for which each Watering Start Time 910 will last. The Run Time Per Cycle 912 will also vary depending on the properties within each zone. For example, if a zone has clay soil type and a high slope, the watering times may begin at multiple times throughout the day and the watering cycle may last for short periods of time in order to prevent run-off of water. In some embodiments, a user may manually adjust the Watering Start Times 910 by selecting a Start Time Adjust arrow 940. Start Time Adjust arrows are provided for each watering start time and allow users to add start times or adjust existing start times. For example, a user may add a watering start time by selecting an up Start Time Adjust arrow or adjust an existing watering start time by selecting either an up or down Start Time Adjust arrow. In some embodiments, if a user has added a watering start time or adjusted an existing watering start time, an indicator is displayed near the new or adjusted watering start time to indicate that a new watering start time has been added or that an existing watering start time has been adjusted. Further, in some embodiments, the indicator may display the suggested watering start time if the user drags a cursor over the indicator. The suggested watering start time corresponds to the original watering start time when the irrigation schedule was first generated. For example, if the user has added a watering start time to the Suggested Watering Schedule 902, an indicator will be displayed near the new watering start time. A user may drag a cursor over the indicator and the indicator will further display that the suggested watering start time is no watering start time.

In some embodiments, Information icon 930 may provide a user with supplemental information regarding the Suggested Watering Schedule 902. For example, in response to user selection of Information icon 930, a dialog box may be displayed explaining that the user may manually adjust various components of the Suggested Watering Schedule 902. Information icon 930 may be generically referred to as a user selectable icon. In some embodiments, the supplemental information may be accompanied by audio. For example, audio may be provided for explaining to the user how to manually adjust the Description 906, the Watering Days 908, or the Watering Start Times 910.

According to several embodiments, a user may select any of the Edit icons 914 if the user desires to return to a zone to edit image selections or edit zone descriptions. In some embodiments, an edit icon is present for each completed zone. In order for a user to edit an incomplete zone, the user may select any of the Zone Incomplete options 916. For example, clicking on one of the Zone Incomplete options 916 returns a user to a zone for which the user has failed to select at least one image. The user may then complete the incomplete zone by selecting at least one image from each selection region.

Monthly Seasonal Adjust Setting 918 provides the user with a percentage for which the user can adjust an irrigation schedule for each month. The percentages correspond to the water necessary to meet an irrigation area's needs according to the season. The seasonal adjust setting helps to prevent over watering and under watering. For example, January has 50% as a monthly seasonal adjust setting, which indicates that based on weather for January at the entered geographic location, the plant life should require 50% of the watering indicated by the schedule. In some embodiments, a user may manually enter the seasonal adjust into a separate irrigation controller for each month, e.g., irrigation controller 122 (see FIG. 1).

In some embodiments, Information icon 920 may provide a user with supplemental information regarding the Monthly Seasonal Adjust Setting 918. For example, in response to user selection of Information icon 920, a dialog box may be displayed informing the user that the percentages may be entered into an irrigation controller each month if the irrigation controller has a seasonal adjust setting. Information icon 920 may be generically referred to as a user selectable icon. Further, in some embodiments, a user may select Learn More option 922 to receive supplemental educational content regarding the Monthly Seasonal Adjust Setting 918. For example, in response to a user selecting Learn More option 922, a dialog box may be displayed explaining the advantages of the Monthly Seasonal Adjust Setting 918. The dialog box may also provide instructions on how and when to enter the seasonal adjust settings into the irrigation controller. The dialog box may further provide examples to the user in order to illustrate how the seasonal adjust settings will affect the irrigation schedule. The use of seasonal adjust settings is well known to those of ordinary skill in the art.

The user has the option to save the irrigation schedule by selecting Save Schedule option 924. If an irrigation schedule is saved, the user may return to the irrigation schedule at any time by selecting Load Saved Schedule option 410 (See FIG. 4). The user may also print the irrigation schedule by selecting Print Schedule option 926.

In some embodiments, the user may turn audio on or off by selecting Audio icon 524. Additional information provided to the user in response to selection of Information icon 920, Information icon 930, and/or Learn More option 922 may be accompanied by audio if the user has turned the audio on by selecting Audio icon 524. The audio may provide instructions, educational information, and/or any other additional information that may aid the user in using the irrigation schedule.

A user may select Introduction option 932 to cause the graphical user interface 900 to display an introduction, which is an introduction to the irrigation scheduler program. The introduction is described in further detail above in accordance with FIG. 3. Start option 934 allows the user to return at any time to a graphical user interface, e.g. graphical user interface 400 (see FIG. 4), in order to create a new schedule or return to a saved schedule. A user may select Zones option 936 to return to a graphical user interface, e.g. graphical user interface 600 (see FIG. 6), in order to edit the user's zone descriptions or image selections. Schedule option 938 is highlighted to indicate to the user that the graphical user interface 900 is currently displaying the irrigation schedule. In some embodiments, the irrigation schedule may be saved in a computer readable medium, e.g. computer readable medium 120 (see FIG. 1). In other embodiments, the irrigation schedule may be sent to a printer for printing, e.g. printer 118 (see FIG. 1). Further, in some embodiments, a user may manually input the irrigation schedule into an irrigation controller. In other embodiments, the irrigation schedule may be transferred or directly input into a separate irrigation controller, e.g., irrigation controller 122 (see FIG. 1).

Referring next to FIG. 10, a diagram is shown that illustrates various ways in which a generated irrigation schedule may be provided to the irrigation controller 122. The irrigation schedule may be provided in a variety of ways. For example, the irrigation schedule may be stored on a variety of different types of computer readable mediums, such as flash memory 1006, universal serial bus (USB) drive 1008, etc. The irrigation schedule may be transferred from one of the various computer readable mediums to the irrigation controller 122 and copied into a memory (not shown) of the irrigation controller 122 via an appropriate input. As another example, the user may print the irrigation schedule from the computer 1002 (the printed schedule illustrated as paper 1004) and manually input the irrigation schedule into the irrigation controller 122 using its user interface. Further, for example, the irrigation schedule may be input or transferred directly into the irrigation controller 122 using a direct computer to controller connection 1010, using a network connection 1012 via network 114 (e.g., Internet), using a wireless communication link 1016 to a wireless receiver 1014 (or wireless transceiver), or using any other suitable means for transferring data. In some embodiments, the computer 1002 comprises the computer readable medium 120, the processor 106, and the external connection 112 (see FIG. 1) and may be a basic general purpose computer, e.g., personal computer (PC), or any other type of computing platform owned and operated by a user. In other embodiments, the computer 1002 comprises the computer readable medium 120, the processor 106, the user input 108, the display 110, and the external connection 112 (see FIG. 1) and may be a basic general purpose computer, e.g., a laptop, or any other type of computing platform owned and operated by a user.

While the invention herein disclosed has been described by means of specific embodiments, examples and applications thereof, numerous modifications and variations could be made thereto by those skilled in the art without departing from the scope of the invention set forth in the claims.

What is claimed is:

1. An apparatus for creating an irrigation schedule for an area to be irrigated, the area having a plurality of characteristics, comprising:
a computer readable medium storing a set of instructions;
a processor coupled to the computer readable medium and adapted to execute the set of instructions to:
cause the display of a graphical user interface comprising a plurality of sets of user selectable graphic images, each set of user selectable graphic images corresponding to a characteristic of the area, and each set having user selectable graphic images corresponding to different properties of the characteristic; and
generate the irrigation schedule in response to user selection of at least one user selectable graphic image from each of the plurality of sets.

2. The apparatus of claim 1, wherein the user selectable graphic images are photographic images.

3. The apparatus of claim 1, wherein the user selectable graphic images illustrate the different properties of the characteristic.

4. The apparatus of claim 1, wherein the characteristic of the area includes two or more of: plant type, sun exposure, plant density, slope, soil type, and sprinkler type.

5. The apparatus of claim 1, wherein the processor is further adapted to cause the irrigation schedule to be saved.

6. The apparatus of claim 1, wherein the processor is further adapted to cause the irrigation schedule to be printed.

7. The apparatus of claim 1, wherein the graphical user interface further comprises a first input region for a user to enter a zip code, and a second input region for a user to select a number of zones in the area.

8. The apparatus of claim 1, wherein the graphical user interface further comprises a third input region for a user to enter a description of at least one zone in the area.

9. The apparatus of claim 1, wherein the graphical user interface further comprises a plurality of display regions, wherein each of the plurality of display regions displays one of the plurality of sets of user selectable graphic images.

10. The apparatus of claim 9, wherein each of the plurality of display regions further displays a description of the characteristic of the area for which each set of user selectable graphic images corresponds.

11. The apparatus of claim 9, wherein each of the plurality of display regions further displays a user selectable icon, wherein, upon selection of the user selectable icon, the processor is configured to execute the set of instructions to display supplemental information.

12. The apparatus of claim 1, wherein upon selection of at least one user selectable graphic image, the at least one user selectable graphic image is highlighted.

13. The apparatus of claim 1, wherein the irrigation schedule comprises:
at least one day of a week in which irrigation is to occur for at least one zone of the area;
at least one time within the at least one day of the week in which irrigation is to start; and
a length of time for which the irrigation will occur.

14. The apparatus of claim 1, wherein the irrigation schedule comprises a seasonal adjust value for at least one month.

15. An apparatus for creating an irrigation schedule for an area to be irrigated, the area having a plurality of characteristics, comprising:
a computer readable medium storing a set of instructions adapted to be executed by a processor coupled to the computer readable medium, when executed, the set of instructions adapted to:
cause the display of a graphical user interface comprising a plurality of sets of user selectable graphic images, each set of user selectable graphic images corresponding to a characteristic of the area, and each set having user selectable graphic images corresponding to different properties of the characteristic; and
generate the irrigation schedule in response to user selection of at least one user selectable graphic image from each of the plurality of sets.

16. A method of creating an irrigation schedule for an area to be irrigated, the area having a plurality of characteristics, comprising:
causing the display of a graphical user interface comprising a plurality of sets of user selectable graphic images, each set of user selectable graphic images corresponding to a characteristic of the area, and each set having user selectable graphic images corresponding to different properties of the characteristic; and
generating the irrigation schedule in response to user selection of at least one user selectable graphic image from each of the plurality of sets.

17. The method of claim 16, wherein the characteristic of the area includes two or more of: plant type, sun exposure, plant density, slope, soil type, and sprinkler type.

18. The method of claim 16, further comprising causing the irrigation schedule to be saved.

19. The method of claim 16, further comprising causing the irrigation schedule to be printed.

20. The method of claim 16, further comprising entering the irrigation schedule into a separate controller.

21. A method for creating an irrigation schedule for an area to be irrigated, the area having at least one zone, comprising:
selecting, at a user interface, at least one user selectable graphic image from a plurality of sets of user selectable graphic images corresponding to two or more of the following characteristics of the at least one zone:
plant type,
sun exposure for the plant type,
plant density,
slope,
soil type, and
sprinkler type;
causing the irrigation schedule to be generated; and
inputting the irrigation schedule having been generated into a separate controller.

22. The method of claim 21, further comprising entering a zip code corresponding to the area.

23. The method of claim 21, further comprising entering a number of zones to be irrigated.

24. The method of claim 21, wherein the plurality of sets of user selectable graphic images comprise photographic images.

25. The method of claim 21, wherein each set of user selectable graphic images comprise a plurality of user selectable images that illustrate different properties of the characteristic.

26. The method of claim 21, further comprising entering an input to save the irrigation schedule.

27. The method of claim 21, further comprising entering an input to print the irrigation schedule.

28. The method of claim 21, wherein the selecting step comprises selecting, at the user interface, the at least one user selectable graphic image from the plurality of sets of user selectable graphic images corresponding to three or more of the following characteristics of the at least one zone: the plant type, the sun exposure for the plant type, the plant density, the slope, the soil type, and the sprinkler type.
